(19) United States
(12) Patent Application Publication
(10) Pub. No.: US 2011/0214901 A1
(43) Pub. Date: Sep. 8, 2011

(54) Electric Fence Insulator

(76) Inventor: Kirk H. Woolf, Rigby, ID (US)

(21) Appl. No.: 12/716,001

(22) Filed: Mar. 2, 2010

(51) Int. Cl. H01B 17/14

(52) U.S. Cl. 174/158 F

(57) ABSTRACT

An electric fence insulator is disclosed, which includes a band, an insulator extension, and a conductor support. The band has an inner wall surface to receive a substantially vertical fence post and an outer wall surface. The insulator extension extends outward from the outer wall surface of the band a distance of at least one inch. The conductor support is disposed on the insulator extension to support a conductor. The band, the insulator extension and the conductor support form a unitary structure.

### BACKGROUND

1. Field of the Invention

The present invention relates to an electric fence insulator. In particular, the present invention relates to an electric fence insulator suitable for use with vinyl or plastic fencing.

2.Background of the Invention and Related Art

An electric fence is a barrier that uses electric shocks to deter animals or people from crossing a boundary. Most electric fencing used today is for agricultural fencing and other forms of animal control purposes, though it is frequently used for enhanced security purposes.

Electric fences are designed to create an electrical circuit when touched. When a person or animal simultaneously touches the electrical conductor and the earth he completes an electrical circuit is completed a pulse, causing a painful electric shock, is conducted. The magnitude of the electrical shock depends upon the voltage, the electrical current used, and the degree of contact with the fence and the ground.

Insulators are used with electric fences to electrically isolate or insulate the electrified fence materials from the earth. Historically, wood or metal posts were driven into the ground and insulators were attached to the posts. A conductive wire was then attached to the insulators and a voltage was applied to the wire. The insulators insulate the post and the earth from the electrically charged wire.

### SUMMARY OF THE INVENTION

In one aspect, a electric fence insulator includes a band having an inner wall surface to receive a fence post and an outer wall surface, an insulator extension extending outward from the outer wall surface of the band a distance of at least one inch, and a conductor support disposed on the insulator extension to support a conductor. The band, the insulator extension and the conductor support form a unitary structure.

Implementations may include one or more of the following features. The band, the insulator extension and the conductor support may substantially consist of the polyvinyl chloride (PVC). The band, the insulator extension, and the conductor support may be made substantially of at least one of plastic, vinyl, and combinations thereof having nonconductive properties. The band, the insulator extension, and the conductor support may be molded into a unitary structure. The inner wall surface may include one or more gripping structures to increase the friction between the inner wall surface of the band and the fence post. The electric fence insulator may include a plate coupled to and extending away from the band and holes disposed in the plate for use in securing the insulator to a fence post or other structure. The insulator extension may extend outward from the outer wall surface of the band a distance of at least two and a half inches. The fence post may be a vertical fence post. The band may form a complete loop having substantially the same shape as the outer surface of the fence post.

In another aspect, an electric fence insulator includes a band having an inner wall surface to receive a vertical fence post and an outer wall surface. The band comprising a first and a second biasing arm. The first and second biasing arms are biased to a closed position, an insulator extension extending outward from the outer wall surface of the band a distance of at least one inch, and a conductor support disposed on the insulator extension to support a conductor. The band, the insulator extension and the conductor support form a unitary structure.

Implementations may include one or more of the following features. The band may include a gap between the first and second biasing arms. The gap may be located opposite the insulator extension on the band. A connecting structure may connect the first and second biasing arms. The length of the gap may be between 0.1-1.5 inches. The first and second biasing arms may overlap. The first and second biasing arms may include one or more connecting structures capable of connecting the first and second biasing arms together when the first and second biasing arms are overlapped. The band, the insulator extension, and the conductor support may be made substantially of molded polyvinyl chloride (PVC).

In another aspect, an electric fence insulator includes a band having an inner wall surface to receive a substantially vertical fence post and an outer wall surface, an insulator extension extending outward from the outer wall surface of the band a distance of at least one inch, a conductor support disposed on the insulator extension to support a conductor, wherein the band, the insulator extension and the conductor support form a unitary structure, and a post cap coupled to the top perimeter edge of the band.

Implementations may include one or more of the following features. The inner wall surface may include gripping structure to support the band in a fixed vertical position on the vertical fence post. The band, the insulator extension, and the conductor support may be made substantially of molded polyvinyl chloride (PVC).

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of an electrical fence system having multiple electric fence insulators, according to some embodiments;

FIG. 2 illustrates a perspective view of an electric fence insulator according to some embodiments;

FIG. 3 illustrates a perspective view of an electric fence insulator according to some embodiments;

FIG. 4 illustrates a top view of an locking feature for an electric fence insulator according to some embodiments;

FIG. 5 illustrates a rear view of a locking feature for an electric fence insulator according to some embodiments;

FIG. 6 illustrates a top perspective view of an electric fence insulator according to some embodiments;

FIG. 7 illustrates a bottom view perspective of an electric fence insulator according to some embodiments;

FIG. 8 illustrates a side view of the electric fence insulator according to some embodiments;

FIG. 9 illustrates a side view of an electric fence insulator according to some embodiments;

FIG. 10 illustrates a side view of an electric fence insulator according to some embodiments;

FIG. 11 illustrates a side view of an electric fence insulator according to some embodiments;

FIG. 12 illustrates a perspective view of an electric fence insulator having a plate according to some embodiments; and

FIG. 13 illustrates a perspective view of an electric fence insulator having a plate according to some embodiments.

### DETAILED DESCRIPTION OF THE PREFERRED EMBODIMENTS

It will be readily understood that the components of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the embodiments of the invention.

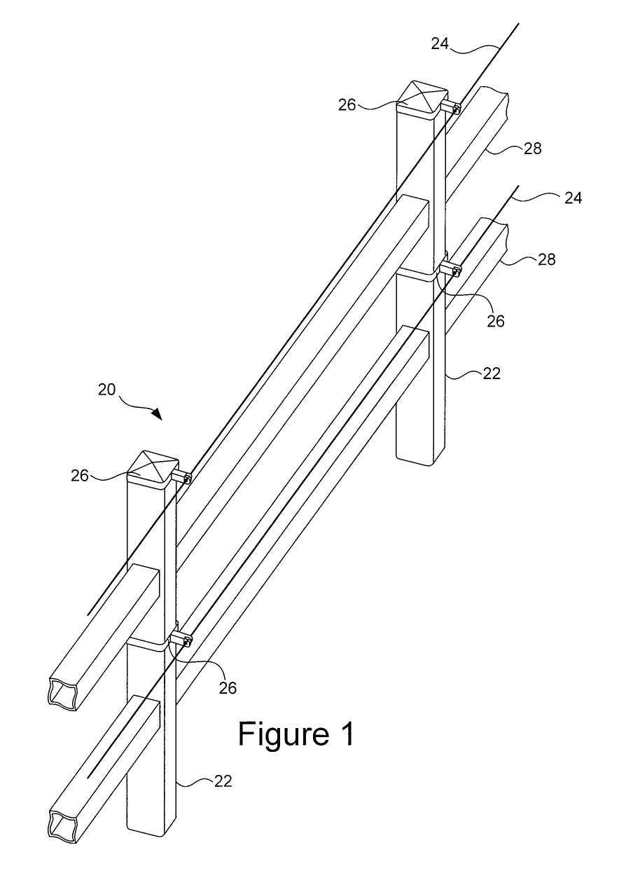

Reference will now be made to FIG. 1, which depicts an electrical fence system 20. The electrical fence system 20 includes one or more vertical fence posts 22 which may be interconnected by one or more horizontal fence posts 28. Electrical fence system 20, as illustrated, also includes multiple electrical fence insulators (also referred to herein simply as “insulators”) 26. Insulators 26 support electrical conductors 24. When an electric charge is placed on electrical conductors 24 electrical conductors 24 can shock any person or object as soon as that contacts is made with electrical conductor 24 and the ground simultaneously without contacting posts 22 or 28. As mentioned above, the ability to shock upon contact can increase the functionality of the fence as a barrier to persons and animals.

In some embodiments, insulators 26 can be installed and used to support an electrical conductor 24 on other non-fence structures. For example, insulators can be attached to buildings, gates, posts, stakes, trellises, tree trunks, and the like. To simplify the description and illustration of the insulator herein, the insulator will generally be described and illustrated as being placed on a fence.

In some embodiments, insulator 26 is configured to be placed on a vertical fence post. In other embodiments, insulator 26 is configured to be placed on a horizontal fence post. In other embodiments, insulator 26 is configured to be placed on a fence post having an angled orientation. To simplify the description and illustration of the insulator herein, the insulator will generally be described and illustrated as being placed on a vertical fence post.

Various materials can be used to construct electrical fence system 20. Historically fences, including vertical and horizontal fence posts 22 and 28, were constructed using metal and/or wood. However, it can be advantageous to construct a fence of plastic or vinyl. A variety of vinyl and plastic materials can be used for this purpose. In some embodiments polyvinyl chloride (PVC) can be used to construct a fence. Plastic and vinyl fences require less maintenance and can be constructed to last for extensive periods of years without need of repair. Plastic and vinyl fences can also be made of a colored material so that they do not need painting. Because plastic and vinyl can be manufactured with a smooth exterior, these fences can take on a smooth exterior. In part because of this smooth exterior it is desirable to prevent making holes, cuts, scratches, and dents in the fence when attaching electric fence insulator 26 or other attachment to these fences. Accordingly, insulators 26 depicted in FIG. 1 and described herein can be installed and used on a plastic or vinyl fence without damaging the fence with scratches, dents, cuts, holes, or other defects.

Various types of electric conductors 24 can be utilized with the insulators described herein. For example, wire conductors can be uses. Wire conductors can be made of smooth steel wire or other like material. Wire can be very thin, or quite thick, such as high-tensile (HT) wire. Additionally, woven wire or barbed wire fences can be used as an electrical conductor. Synthetic webbing, ribbon, polyrope, polywire, polytape, and other electric fencing materials may also be used. These materials are woven with fine conducting wires (e.g. stainless steel). Woven conductors are particularly useful for areas requiring additional visibility or as temporary fencing. The insulators 26 can be manufactured to support these different varieties of electric conductors 24.

With continued reference to FIG. 1, it will be understood that a fence owner may desire to quickly modify, replace, rearrange, or install insulators 26 and electrical conductors 26 of a fence. Due to the structure and the function of the current invention, insulators 26 may be temporarily attached to posts when only temporary barriers are needed. Thus, insulators 26 illustrated in FIG. 1 and described herein can be quickly installed to a fence system without requiring tools, or unreasonable effort. Rather, the insulators described herein may be slid on, snapped on, or simply placed on a fence. If the need arises to modify or replace these insulators, they may likewise be removed without excessive effort. Accordingly, these insulators allow fence owners to efficiently install, maintain, and repair their electrical fence system 20.

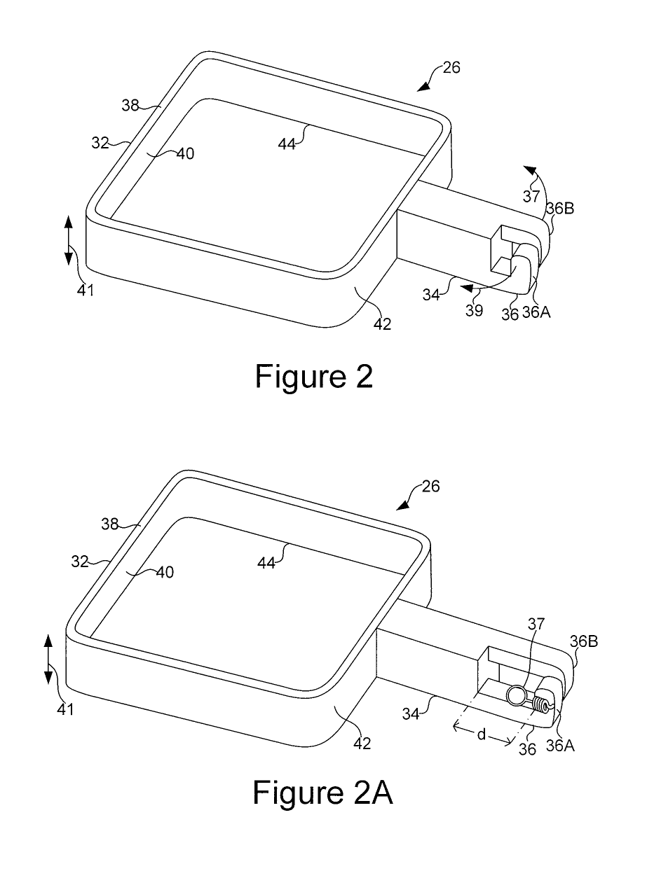

Referring now to FIG. 2, which illustrates an embodiment of an insulator 26. Insulator 26 includes a band or band portion 32. Band 32 includes an inner wall surface 40, and outer wall surface 42, a top perimeter edge 38, and a bottom perimeter edge 44. In some embodiments, the shape of inner wall surface 40 of the band 32 is configured to receive a fence post within the area defined by inner wall surface 40. Accordingly, the shape of inner wall surface 40 may be approximately equal to the shape of the outer surface of a fence post, fence rail, or other object. For example, inner wall surface 40 of the band can be approximately a three inch by three inch square for use with fence posts that are three by three inch square posts. In some embodiments, the band is configured to have an inner surface shaped to be substantially a four by four inch square or a six by six inch square. Likewise, in other embodiments, the band can be rectangular, circular, or any other shape in order to accommodate the outer perimeter of a fence post, fence rail, or other object.

The insulator includes insulator extension 34 extending from outer wall surface 42 of band 32. A conductor support 36 can be included along the length of insulator extension 34, a distance from band 32. Conductor support 36 supports an electrical conductor element, such as a conductive wire, ribbon, or other conductive element. A variety of conductor support 36 configurations can be included on insulator 26, as will be discussed in greater detail below in relation to FIG. 9. In some embodiments, conductor support 36 includes two portions 36A and 36B, which support a conductor. In some embodiments, conductor support 36 positions a conductor in a plane substantially parallel to a plane created by top perimeter edge 38 of band 32.

Insulator extension 34 positions an electrical conductor 24 at a distance from the fence structure to protect the fences. By extending the electrical conductor a sufficient distance away from the fence structure, the fence will be protected from any heat created in the electrical conductor and from any charring that may occur if the electrical conductor contacts portions of the fence. Additionally, insulator extension 34 protects the fence by increasing the chances that contact with conductor 24 occurs prior to contact with the fence. Particularly when electrical fence systems are used to prevent animals from crossing a border and/or damaging a fence structure it is desirable to prevent the animal from contacting or pushing upon the fence at all. Some vinyl and/or plastic fencing is substantially more fragile than wood or metal fencing (particularly at low temperatures) and may break if an animal pushes or leans against it. Accordingly, with plastic and/or vinyl fences is can be important to extend the electrical conductor farther away from the fence in order to decrease the likelihood that an animal come near enough to the fence to cause it harm. Rather an animal will be shocked when it contacts the extended electrical conductor before it gets close enough to contact and damage the fence. Accordingly, in some embodiments, insulator extension 34 extends between one and twelve inches away from outer wall surface 42 of band 32. In more particular embodiments, insulator extension 34 extends between one and a half to four inches from outer wall surface 42 of band 32. In some embodiments, insulator extension 34 extends greater than twelve inches from band 32. In other embodiments, insulator extension 34 extends less than one inch from the band. The length of insulator extension 34 may vary based on the intended use of the electrical fence system.

As shown in FIG. 2A, an alternative embodiment is presented. Insulator extension 34 is configured to provide a gap 39 such that a length of extension 34 which receives conductor 24 has a lateral gap of length d, which permits conductor 24 to move laterally or horizontally within extension 34 without applying significant pressure against the supporting post. In this way if livestock contact conductor 24 the conductor 24 may move laterally toward the support post before any of the weight of the livestock is exerted against the post. Length d may be any desired distance. A biasing member or spring 37 may be disposed on extension 34 and attached to conductor 24 to keep conductor 24 biased away from the support post.

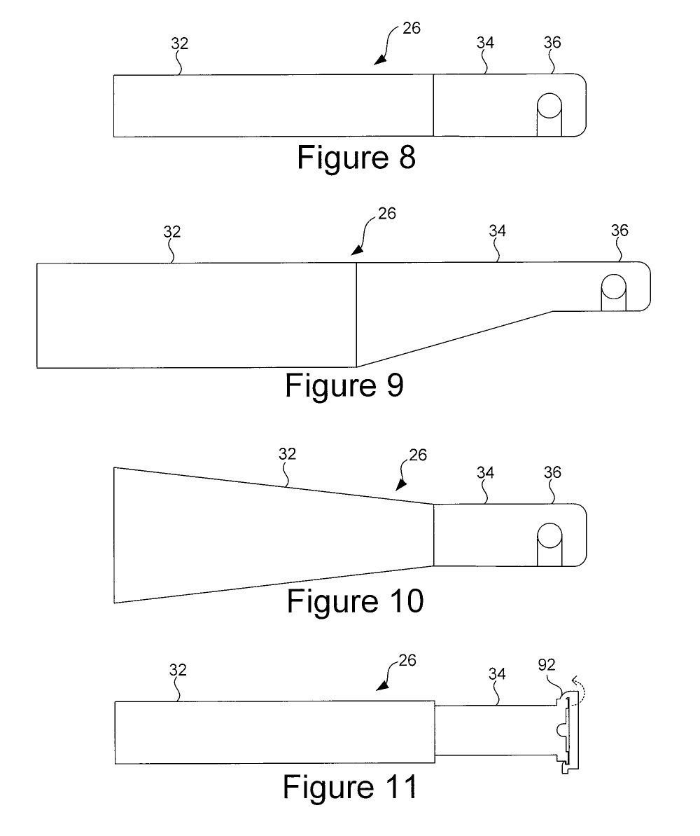

The height 41 of the insulator band 32 may vary based upon the parameters of the fence system. For example, the band height may vary if the perimeter of the post is varies (as illustrated in FIGS. 8-9), if the insulator extension extends relatively far from the band, or if the electrical conductor 24 is relatively heavy. In some embodiments, the band width is approximately between one-quarter inches to four inches. In a more particular embodiment, the band width is approximately one and one half inches in width. In some embodiments that height 41 of the band 32 increased from front to back, as illustrated in FIG. 10. The embodiment of FIG. 10 is described in greater detail below.

Referring to FIG. 2, in some embodiments, the entire insulator 26 including the band 32, the insulator extension 34, and the conductor support 36 form a unitary structure. The term “unitary structure” as used herein refers to a structure that has no separable components. Accordingly, in some embodiments, the insulator 26 is formed as a single-piece structure having no joints or seams. In some embodiments, the insulator 26 is molded in a molding process. And in some embodiments, the insulator 26 is formed from a single material. In other embodiments, the insulator 26 is made of several materials, with each portion (the band 32, the insulator extension 34, and the conductor support 36) ultimately being united to form a unitary structure. For example, in some embodiments the insulator extension 34 is made of a flexible material, more flexible than the material used to make the band 32. In these embodiments, the insulator extension 34 is permanently secured to the band 32. Accordingly, in some embodiments, the insulator extension 34 is capable of bending up to ninety degrees from its resting orientation without breaking or becoming deformed, as illustrated by arrows 37 and 39. A flexible insulator extension 34 allows the insulator 26 to sustain an impact without moving around on or falling off of a fence post. This also acts to absorb lateral pressure exerted by livestock to prevent damage to the support post.

In other embodiments, insulator extension 34 and/or tconductor support 36 is separable from the band. Occasionally, a portion of insulator 26 may break and it may be advantageous to replace only the broken portion. Accordingly, it may be beneficial to allow the portions of insulator 26 to be separable. In some embodiments, the portions are coupled using a screw, pin, a mechanical juncture, an adhesive, or other such fastener. However, to facilitate installment, in some embodiments, it can also be advantageous for the entire insulator 26 to be assembled when sold.

Insulator 26 can be made of a variety of materials and combinations of materials. In some embodiments, insulator 26 is made substantially of a synthetic plastic or vinyl, such as polyvinyl chloride (PVC), polyethylene, polypropylene, or combinations thereof. In other embodiments, insulator 26 is made of another equivalent substantially insulating material.

In some embodiments, it can be beneficial to match the color and material of the insulator to that of the fence material. In this way, the insulator can be discrete and blend in with the fence, rather than appear obvious and mismatched. For example, a white vinyl fence insulator might be perceived as more attractive than other colors and materials when installed on a white vinyl fence.

As illustrated in FIG. 2, insulator 26 can be slid over a fence post during construction or when a post cap is removed. In some embodiments, insulator 26 can be slid over and down a vertical fence post and at rest the junction of a vertical and horizontal post. In some embodiments, the inner dimensions of insulator 26 are configured to be sufficiently similar to those of a fence post to provide a snug fit between insulator 26 and the post so that insulator 26 can remain in a fixed position on a fence post without resting on a horizontal post. In this situation, the insulator is maintained in a vertical position along the vertical post due to the friction between insulator 26 and the post. In some embodiments the inner wall surface 40 of insulator 26 includes one or more gripping structures, as described below.

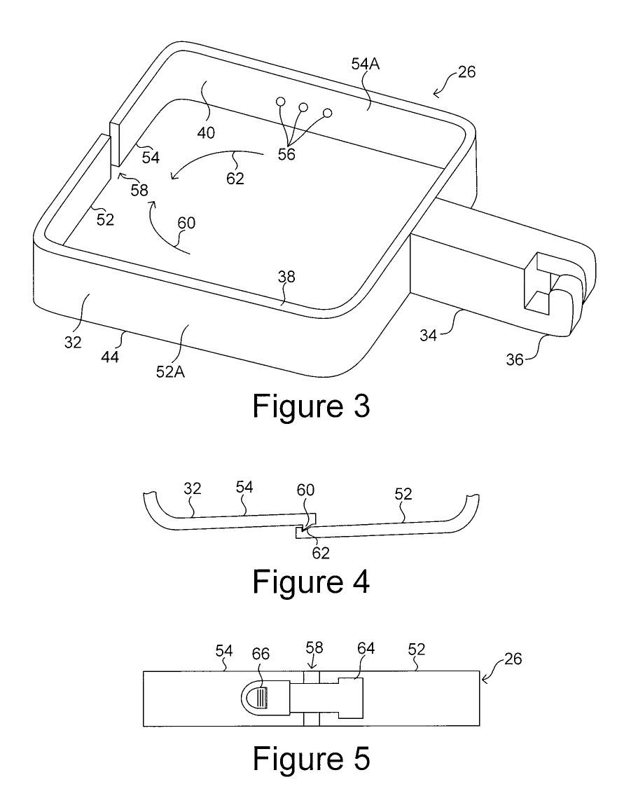

Referring now to FIG. 3, an embodiment of insulator 26 is depicted. The insulator includes band 32 having a gap 58 that separates a first biasing arm 52 from a second biasing arm 54. In use first and second biasing arms 52 and 54 can be pulled apart so that gap 58 is wide enough to allow biasing arms 52 and 54 to be wrapped around a fence post. When insulator 26 is installed, the biasing arms are released and subsequently close to grip the post by applying inward biasing forces 60 and 62 to the post. In this manner, insulator 26 can be quickly snapped into position on an existing fence post, fence rail, or other object.

In some embodiments, insulator 26 is made of a material that is capable of being biased apart without breaking and snapped closed to hold the insulator in a fixed position on a fence. In some embodiments, insulator 26 is sufficiently rigid to be capable of sustaining an impact while still maintaining a high degree of flexibility on biasing arms 52 and 54. In some embodiments, insulator 26 is made of a synthetic plastic such as polyvinyl chloride (PVC). In other embodiments, insulator 26 is made of polyvinyl chloride (PVC), polyethylene, polypropylene, or combinations thereof. In some embodiments, insulator 26 is a unitary structure. In some embodiments, insulator 26 is formed in a molding process.

With continued reference to FIG. 3, in some embodiments, the gap 58 is located on the band opposite the insulator extension 34, as illustrated. The location of gap 58 may be referred to as the rear of the insulator 26. In other embodiments, gap 58 is located on another location on the band 32, such on a first portion 52A of first biasing arm 52, on a first portion 54A of second biasing arm 54, or near insulator extension 34 (on the front of the insulator). In some instances it can be advantageous to locate gap 58 on the rear of insulator 26, as illustrated, because it allows insulator 26 to remain in position when an animal or other object leans onto or applies an inward force to insulator 26 or electric conductor 24. If an animal or other object applied such an inward force on insulator 26, either directly or via conductor 24, this inward force will not cause biasing arms 52 and 54 open.

In some embodiments, the length of the gap 58 is less than one half the length of the rear side of the band 32. In some embodiments, gap 58 is very narrow, such as approximately 0.1 inches. In other embodiments, gap 58 is longer, such as up to two inches in length.

In some embodiments, biasing arms 52 and 54 are bias to a closed position, such that each of the biasing arms tends to the closed position. In some embodiments, a closed position is the position wherein first portion 52A of first biasing arm 52 is parallel to the first portion 54A of second biasing arm 54. Alternatively or additionally, in some embodiments, a closed position is achieved when gap 58 is closed to approximately a predetermined distance. For example, the biasing arms may be biased to a position that creates a gap of ½ inch between arms 52 and 54 when installed on a fence post. Accordingly, when insulator 26 is wrapped around a fence post, first and second biasing arms 52 and 54 bias to a closed position, such that the gap is closed to the distance of approximately ½ inch. In some embodiments, biasing arms 52 and 54 are biased to apply an inward force 60 and 62 respectively. When insulator 26 is installed on a fence post, these biasing arms apply the inward force 60 and 62 toward the fence post and toward a closed position. These forces combine to hold insulator 26 in a fixed position on the fence post, even when installed on a vertical fence post.

With continued reference to FIG. 3, in some embodiments, insulator 26 includes one or more gripping structures 56 disposed on inner wall surface 40 of band 32 to increase the friction between the inner wall surface 40 and the fence post, fence rail, or other object. In some embodiments, gripping structure 56 is a roughened or tacky surface. In some embodiments, gripping structure 56 includes one or more ridges, ribs, bumps, barbs, or any other raised relief geometric shape along a portion of inner wall surface 40 of the band 32. In some embodiments, gripping structure 56 includes an adhesive deposited on inner wall surface 40 of the band 32. In some embodiments, the insulator has no gripping structure 56, but rather one or more of the insulators' edges or surfaces may be naturally roughened or jagged when molded or cut.

Referring now to FIG. 4, which depicts a top view of a portion of a band 32 according to some embodiments. In some embodiments, first and second biasing arms 52 and 54 include one or more connecting structure that connect or interlock the first and second biasing arms together when the arms are in a closed position. The connecting structure(s) can hold the biasing arms in a closed position. Additionally, the connecting structure(s) can function to tighten the biasing arms' grip on the fence post and hold insulator 26 in position on a fence post. The ability to secure first and second biasing arms 52 and 54 in a closed position is desirable and allows a user to secure biasing arms 52 and 54 tightly closed without damaging or scarring the fence itself.

As illustrated in FIG. 4, in some embodiments, first and second biasing arms 52 and 54 overlap when in a closed position. In some embodiments, first biasing arm 52 includes a first connecting feature 62 and second biasing arm 54 includes a second connecting structure 64 that extends from the second biasing arm 54 into first connecting structure 62 of first biasing arm 52 to connect these two arms in a closed position. In an alternative embodiment (not shown), first and second biasing arms 52 and 54 include opposite facing hook-shaped ends that interlock together when the biasing arms overlap. Various other types of connecting structures can be used with insulator 26 to connect the biasing arms together in a closed position and/or to tighten the grip of the biasing arms around a fence post without damaging the post.

Referring now to FIG. 5, which depicts a rear view of band 32 according to some embodiments. A connecting tab 64 disposed on arm 52 connects about raised button 66 disposed on arm 54 to join first and second biasing arms 52 and 54 across a gap 58. A connecting structure can be coupled to the first and/or second biasing arms 52 and 54 so that these arms can be selectively connected together to ensure that biasing arms 52 and 54 remain in a closed position. Various types of connecting structure may be used with the insulator 26. FIG. 5 illustrates a first connecting structure 64 in the form of a snap-in clip. In other embodiments the connecting device may include a latching connector, a belt-like connector, or other connector types. Alternatively, in some embodiments, a separate connecting structure can be added onto the insulator to connect first and second biasing arms 52 and 54, such as adhesive tape, a staple, a pin, or the like.

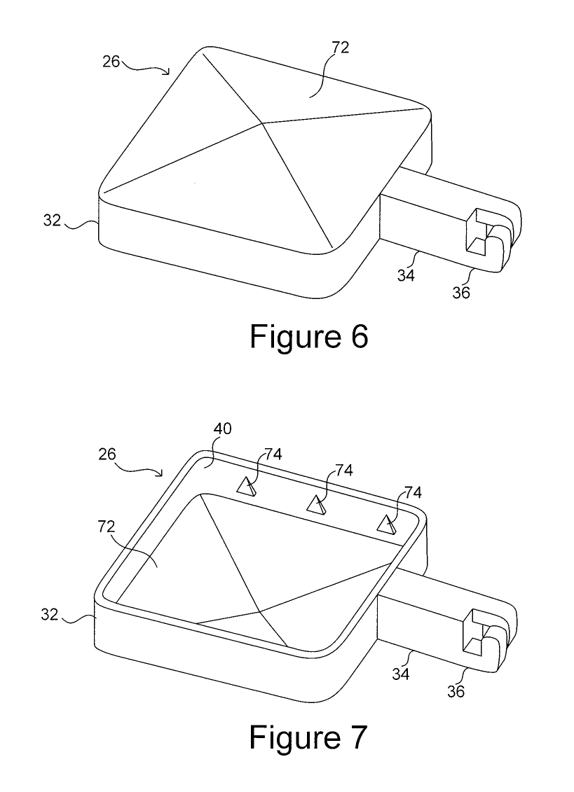

Referring now to FIGS. 6-7, in some embodiments the insulator 26 includes a cap 72 that allows the insulator 26 to function as a cap or end piece on a fence post or rail. In use, insulator 26 can be inserted over a fence post until the post contacts the inner surface of the cap 72. In some embodiments, the insulator 26 rests on the fence post under the force of gravity. Alternatively or additionally, in some embodiments, the band 32 of the insulator 26 fits snuggly on a fence post to hold the cap in place via the friction fit between the insulator band and the fence post. As illustrated, in some embodiments, the cap 72 includes an angled shape directed away from the band 32. In other implementations, the cap can have other forms including flat, curved, domed, etc.

FIG. 7 illustrates some embodiments of an insulator 26 having a cap 72. As illustrated, insulator 26 is oriented up-side-down, with the cap on the bottom. In some embodiments, inner wall surface 40 of band 32 includes one or more gripping structure(s) 74. In some embodiments, gripping structure(s) 74 are configured to secure the cap in place on the post by preventing the cap from being removed by a minor force. In some embodiments, gripping structures 74 are positioned only on one or two sides of insulator 26 so that insulator 26 can be removed from the fence post by squeezing inward the sides without gripping structures 74 and pulling insulator 26 away from the post. This method will prevent gripping structures 74 from damaging the fence post.

Referring now to FIG. 8, which depicts a side view of an insulator 26. As illustrated insulator 26 includes a band 32, an insulator extension 34, and a conductor support 36. A variety of conductor support types can be utilized with insulator 26 to support an electric conductor 24. The illustrated conductor support 36 includes two parts, each molded into a hook-like shape. A three-dimensional view of conductor support 36 is depicted in FIGS. 1-3 and 6-7. One part 36A includes a hook-like shape in an upward orientation, allowing for an electric conductor to rest within the opening of the hook shape. The other part 36B is another hook-like shape opened in a downward direction to secure the conductor in place on the insulator extension 34. FIG. 8 illustrates that the combination of the two parts 36A and 36B of the conductor support 36 combine to form a substantially circular passage for a conductor to pass through.

Referring now to FIG. 9, which depicts a side view of an insulator 80 according to some embodiments. As illustrated, insulator extension 34 extends outward from the band a distance farther than that of FIG. 8. To provide increased support to the insulator 80, band 32 is taller than the band of FIG. 8 and the insulator extension 80 has an angled geometry. These two modification provide increased support to the insulator 80 so that the insulator 80. In some embodiments, the insulator extension can be modified merely by increasing the length without including an angled geometry. In some embodiments, the dimensions of the band and insulator extension can be modified to accommodate the various needs of any particular electrical fence system.

Referring now to FIG. 10, which depicts a side view of an insulator 26 according to some embodiments. As illustrated, the height of the band 32 increased from front to back. This variation in height can provided increased structural support to the insulator.

Referring now to FIG. 11, which depicts a side view of an embodiment of an insulator 90 having a band 32, an insulator extension 34, and a conductor support 92. As illustrated conductor support 92 is a clip, which receives either a wire, ribbon, or other electrical conductor and holds the conductor in a fixed position by means of a clip. A variety of other types of conductor supports can be used with to retain the electrical conductor including a pin-lock, a clip, a loop, a sleeve, a slot, etc.

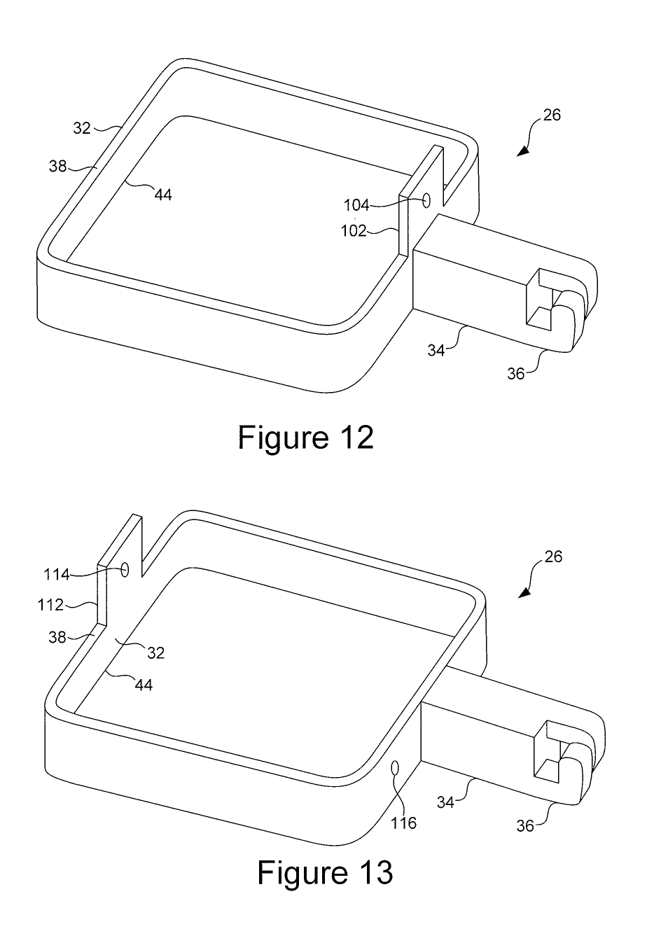

Reference will now be made to FIG. 12, which depicts an insulator 100 having a plate 102 and hole 104. In some embodiments, it may be useful to provide a predrilled hole 104 in the insulator so that a user can insert a nail, screw, staple, tack, bolt, rivet, or other like fastener component through hole 104 and into the fence post. The addition of this fastener component can secure insulator 100 in a fixed location on a fence post. In some embodiments, the hole has a diameter equaled to approximately the size of a screw or nail useful in securing the insulator to a fence. Predrilled hole 104 can be particularly useful to provide additional support to insulator 100 when the insulator does not snuggly fit around a fence post or other object. Accordingly, a user can secure insulator 100 to the post using the hole and a fastener component.

In some embodiments, a predrilled hole 104 is included on a plate 102 extending from the band 32, near insulation extension 34. In some embodiments, hole 104 is located near the center of the plate 102. Plate can be an extension of the band 32 and is part of the unitary structure of band 32, insulator extension 34, and conductor support 36. In some embodiments, the entire insulator 100 including plate 102 is molded as a single unit. In some embodiments, plate 102 is sized with a width between one-quarter to two inches and the length of the plate is between one-half to two inches. In some embodiments, plate 102 is one inch by one inch.

Referring now to FIG. 13 in some embodiments, an insulator includes plate 112 with a predrilled hole 114 disposed on band 32 opposite the insulator extension 34. Additionally or alternatively, in some embodiments, a hole 116 is located on band 32. In these embodiments, the hole may be located anywhere on band 32.

The advantages of the present invention include, without limitation, the ease by which this unit can be installed and uninstalled onto a fence, especially a plastic or vinyl fence. As a unitary structure, each insulator can be installed in a matter of seconds without the need of penetrating hardware such as nails, screws, bolts, staple, or other similar devices. Yet, the insulator retains the option to use such a fastening device if the installer so desires. Because the insulator unit can be molded of a synthetic vinyl or plastic product to exact specifications for size, it can be mounted tightly around a fence post, and effectively limits the range of motion that said insulator can experience when mounted. Because the insulator does not of necessity require the use of such penetrating hardware, it is non-destructive to the fence post in which it is mounted. And because the insulator extends the conductor outward a reasonable distance, the fence is protected from impacts and other forces that would otherwise damage the fence. This product is also advantageous in that it can blend nicely with the synthetic vinyl or plastic fence to which it is attached, making it blend in with the fence and appear aesthetically pleasing.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed:

1. A electric fence insulator comprising:
a band having an inner wall surface to receive a fence post and an outer wall surface;
an insulator extension extending outward from the outer wall surface of the band a distance of at least one inch; and
a conductor support disposed on the insulator extension to support a conductor, wherein the band, the insulator extension and the conductor support form a unitary structure.

2. The electric fence insulator of claim 1, wherein the band, the insulator extension and the conductor support substantially consist of the polyvinyl chloride (PVC).

3. The electric fence insulator of claim 1, wherein the band, the insulator extension, and the conductor support are made substantially of at least one of plastic, vinyl, and combinations thereof.

4. The electric fence insulator of claim 1, wherein the inner wall surface includes one or more gripping structures to increase the friction between the inner wall surface and the fence post.

5. The electric fence insulator of claim 1, further comprising a plate coupled to and extending away from the band and hole disposed in the plate.

6. The electric fence insulator of claim 1, wherein the insulator extension extends outward from the outer wall surface of the band a distance of at least two and a half inches.

7. The electric fence insulator of claim 1, wherein the fence post is a vertical fence post.

8. The electric fence insulator of claim 1, wherein the band forms a complete loop having substantially the same shape as the outer surface of the fence post.

9. The electric fence insulator of claim 1, wherein the conductor support comprises a lateral gap for permitting lateral movement of an electrical conductor within the conductor support.

10. An electric fence insulator comprising:
a band having an inner wall surface to receive a vertical fence post and an outer wall surface, the band comprising a first and a second biasing arm, wherein the first and second biasing arms are biased to a closed position;
an insulator extension extending outward from the outer wall surface of the band a distance of at least one inch; and
a conductor support disposed on the insulator extension to support a conductor, wherein the band, the insulator extension and the conductor support form a unitary structure.

11. The electric fence insulator of claim 10, wherein the band includes a gap between the first and second biasing arms.

12. The electric fence insulator of claim 11, wherein the gap is located opposite the insulator extension on the band.

13. The electric fence insulator of claim 11, further comprising a connecting structure that connects the first and second biasing arms across the gap.

14. The electric fence insulator of claim 11, wherein the length of the gap is between 0.1-1.5 inches.

15. The electric fence insulator of claim 10, wherein the first and second biasing arms overlap when in a closed position.

16. The electric fence insulator of claim 15, wherein the first and second biasing arms include one or more connecting structures capable of connecting the first and second biasing arms together when the first and second biasing arms are overlapped.

17. The electric fence insulator of claim 10, wherein the band, the insulator extension, and the conductor support are substantially of molded polyvinyl chloride (PVC).

18. An electric fence insulator comprising:
a band having an inner wall surface to receive a substantially vertical fence post and an outer wall surface;
an insulator extension extending outward from the outer wall surface of the band a distance of at least one inch;
a conductor support disposed on the insulator extension to support a conductor, wherein the band, the insulator extension and the conductor support form a unitary structure; and
a cap coupled to the top perimeter edge of the band.

19. The electric fence insulator of claim 18, wherein the inner wall surface includes gripping structure to support the band in a fixed vertical position on the vertical fence post.

20. The electric fence insulator of claim 18, wherein the band, the insulator extension, and the conductor support are made substantially of molded polyvinyl chloride (PVC).
